(19) United States
(12) Patent Application Publication
(10) Pub. No.: US 2023/0393167 A1
(43) Pub. Date: Dec. 7, 2023

(54) AUTOMATIC ANALYZER AND AUTOMATIC ANALYZING METHOD

(71) Applicant: Canon Medical Systems Corporation, Otawara-shi (JP)

(72) Inventor: Shozo HASHIMOTO, Nasushiobara (JP)

(73) Assignee: Canon Medical Systems Corporation, Otawara-shi (JP)

(21) Appl. No.: 18/328,920

(22) Filed: Jun. 5, 2023

(30) Foreign Application Priority Data
Jun. 7, 2022 (JP) 2022-092346

(51) Int. Cl. G01N 35/10; G01N 35/00

(52) U.S. Cl. CPC G01N 35/1016; G01N 2035/00673; G01N 35/00663

(57) ABSTRACT

According to one embodiment, an automatic analyzer is configured to dispense a subject sample or a standard sample and a reagent into a reaction container and to subject a mixture liquid in the reaction container to measurement. The automatic analyzer includes control circuitry. The control circuitry is configured to acquire, from a standard sample container containing the standard sample, standard sample information comprising at least one of item information, identification information for identification as a calibrator or an accuracy management sample, or concentration information. The control circuitry is configured to update, upon acquisition of the standard sample information, condition information on a condition of the standard sample.

### CROSS-REFERENCE TO RELATED APPLICATION(S)

This application is based upon and claims the benefit of priority from prior Japanese Patent Application No. 2022-092346, filed Jun. 7, 2022, the entire contents of which are incorporated herein by reference.

### FIELD

Embodiments described herein relate generally to an automatic analyzer and an automatic analyzing method.

### BACKGROUND

Generally, measurement with a standard sample (hereinafter, “standard sample measurement”) performed by an automatic analyzer requires the user to place a standard sample container containing the standard sample into the automatic analyzer. Effective implementation of a standard sample measurement, such as calibration measurement and accuracy management measurement using a standard sample, could be hampered depending on a condition of the standard sample. As one example, performing standard sample measurement with an expired standard sample would result in a failure to acquire a valid calibration curve, inability to perform accuracy management, and so on. As another example, performing standard sample measurement with an insufficient remaining amount of a standard sample does not allow for a sufficient measurement level, and therefore, would result in a waste of a reagent. As such, it is desirable that the use of standard samples that are in an inadequate condition be avoided.

### BRIEF DESCRIPTION OF THE DRAWINGS

FIG. 1 is a block diagram showing a functional configuration of an automatic analyzer according to a first embodiment.

FIG. 2 is a schematic diagram showing an exemplary design of components pertaining to the automatic analyzer according to the first embodiment.

FIG. 3 is a schematic diagram showing one example of an appearance of a standard sample container according to the first embodiment.

FIG. 4 is a schematic diagram for explaining one example of a structure of the standard sample container according to the first embodiment.

FIG. 5 is another schematic diagram for explaining said one example of the structure of the standard sample container according to the first embodiment.

FIG. 6 is a flowchart for explaining operations in the first embodiment.

FIG. 7 is a flowchart for explaining operations in a second embodiment.

FIG. 8 is another flowchart for explaining operations in the second embodiment.

### DETAILED DESCRIPTION

In general, according to one embodiment, an automatic analyzer is configured to dispense a subject sample or a standard sample and a reagent into a reaction container and to subject a mixture liquid in the reaction container to measurement. The automatic analyzer includes control circuitry. The control circuitry is configured to acquire, from a standard sample container containing the standard sample, standard sample information comprising at least one of item information, identification information for identification as a calibrator or an accuracy management sample, or concentration information. The control circuitry is configured to update, upon acquisition of the standard sample information, condition information on a condition of the standard sample.

The embodiments will be described with reference to the drawings.

### First Embodiment

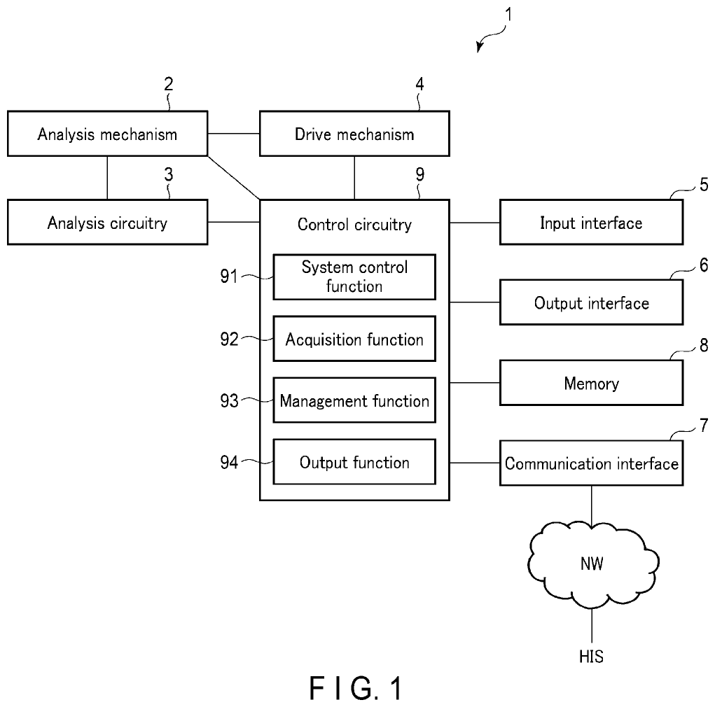

FIG. 1 is a block diagram showing a functional configuration of an automatic analyzer according to the first embodiment. The automatic analyzer shown in FIG. 1, denoted by “1”, is an apparatus adapted to dispense a subject sample or a standard sample and a reagent into a reaction container and to subject the mixture liquid in the reaction container to measurement. This automatic analyzer 1 includes an analysis mechanism 2, analysis circuitry 3, a drive mechanism 4, an input interface 5, an output interface 6, a communication interface 7, a memory 8, and control circuitry 9.

The analysis mechanism 2 reads standard sample information from each standard sample container containing a standard sample and sends the read information to the control circuitry 9. The analysis mechanism 2 mixes a sample, such as a standard sample or a subject sample, with a reagent for a test item set for the sample. The analysis mechanism 2 subjects the mixture liquid of the sample and the reagent to measurement and generates standard data and subject data, which are represented as, for example, absorbency levels. Examples of the standard sample include a calibrator for use in calibration measurement for preparing a calibration curve, an accuracy management sample (a control sample) for use in accuracy management measurement for ensuring the accuracy of a calibration curve, and so on.

The analysis circuitry 3 is a processor to analyze the standard data and the subject data, generated by the analysis mechanism 2, to generate calibration data and analysis data. The analysis circuitry 3 reads an analysis program from the memory 8 and generates the calibration data, the analysis data, etc., according to the read analysis program. Here, the calibration data is indicative of, for example, a relationship between the standard data and a standard value predetermined for the standard sample, and the analysis circuitry 3 generates the calibration data based on the standard data. Also, the analysis data may be represented as a concentration value and an enzyme activity value, and the analysis circuitry 3 generates the analysis data based on the subject data and the calibration data for the test item corresponding to the subject data. The analysis circuitry 3 outputs the generated data including the calibration data, the analysis data, etc. to the control circuitry 9.

The drive mechanism 4 drives the analysis mechanism 2 under the control of the control circuitry 9. The drive mechanism 4 is realized by, for example, a gear, a stepping motor, a belt conveyor, a lead screw, and so on.

The input interface 5, in one example, accepts settings for analysis parameters, etc. associated with each test item intended for a measurement-requested blood sample, from an operator or via an in-hospital network NW. The input interface 5 is realized by, for example, one or more of a mouse, a keyboard, a touch pad on which instructions are input by touching an operation screen, and so on. The input interface 5 is connected to the control circuitry 9 so that it converts operational commands input by an operator into electric signals and outputs them to the control circuitry 9. In the disclosure herein, the input interface 5 is not limited to physical operating components such as a mouse and a keyboard. Examples of the input interface 5 also include processing circuitry for electric signals which is adapted to receive an electric signal corresponding to an operational command input from an external input device separate from the automatic analyzer 1, and to output this electric signal to the control circuitry 9.

The output interface 6 is connected to the control circuitry 9 and outputs signals coming from the control circuitry 9. The output interface 6 is realized by, for example, one or more of display circuitry, print circuitry, an audio device, and so on. Such display circuitry may be a CRT display, a liquid crystal display, an organic EL display, an LED display, a plasma display or the like. Also, the display circuitry may include processing circuitry for converting data of a display subject into video signals and supplying the video signals to external entities. The print circuitry may be a printer or the like. The print circuitry may also include output circuitry for supplying data of a print subject to external entities. The audio device may be a speaker or the like. Examples of the audio device also include output circuitry for supplying audio signals to external entities.

The communication interface 7, in one example, is connected to the in-hospital network NW. The communication interface 7 performs data communication with a hospital information system (HIS) via the in-hospital network NW. It is also possible for the communication interface 7 to perform data communication with the HIS via a laboratory information system (LIS) connected to the in-hospital network NW.

The memory 8 may be, for example, a processor-readable storage medium such as a magnetic or an optical storage medium or a semiconductor memory. Note that it is not required to realize the memory 8 by a single storage device. For example, the memory 8 may be realized by multiple storage devices.

The memory 8 stores one or more analysis programs for the analysis circuitry 3 to execute, and one or more control programs for the control circuitry 9 to realize its functions. The memory 8 stores, for each test item, the calibration data generated by the analysis circuitry 3. The memory 8 also stores, for each sample, the analysis data generated by the analysis circuitry 3. The memory 8 stores a test order input from an operator, or a test order received by the communication interface 7 via the in-hospital network NW. The memory 8 stores, for each standard sample, standard sample information and condition information. The memory 8 may store one or more sets of such standard sample information and condition information for a predetermined placement quantity and/or a predetermined period. The memory 8 is one example of a storage.

In one example, the standard sample information includes at least one of item information, identification information for the identification as a calibrator or an accuracy management sample, and/or concentration information. In addition to the item information, the identification information, and/or the concentration information, the standard sample information may also include various sets of information, such as a reagent name, an expiration timing of the standard sample, a valid period after opening, an expected number of uses (before opening), a lot number, a product number, and a calibrator level, as appropriate. Here, the expected number of uses (before opening) indicates how many times the standard sample contained in an unopened standard sample container can be used. It is preferable that the standard sample information include the concentration information since standard samples under different lot numbers may vary in concentration values.

In one example, the condition information includes information on at least one of the expiration timing of a standard sample and/or the remaining amount of the standard sample. Examples which may be used as the information on the expiration timing include information indicative of a period start timing, such as the date and time of placement or opening of a standard sample container. Other examples of the information on the expiration timing include the date and time of use of a standard sample, the date and time of measurement, the date and time of acquisition of standard sample information, and so on. In instances where the standard sample information does not include the expiration timing of a standard sample or the valid period after opening of the standard sample, the condition information may additionally include such information. Examples which may be used as the information on the remaining amount include information indicative of the number of times the standard sample has been used in measurement. This number of uses used in measurement is equal to or smaller than the expected number of uses (before opening). The number of uses used in measurement may be updated in such a manner that the usage is cumulatively counted for each timing (date and time) of use in measurement, and the total number of uses for these use timings (dates and times) may be calculated at the time of checking the remaining amount. As another option, the number of uses used in measurement may be updated in such a manner that the total number of uses is calculated and the number of uses is overwritten by the obtained total value at each timing of use in measurement. In instances where the standard sample information does not include the expected number of uses (before opening), the condition information may further include such information. The condition information may also be called “condition history information”.

The control circuitry 9 is, for example, a processor functioning as a center of the automatic analyzer 1. The control circuitry 9 executes the program or programs stored in the memory 8 to realize functions corresponding to the executed program or programs. For example, the control circuitry 9 runs the control programs to realize a system control function 91, an acquisition function 92, a management function 93, and an output function 94. Note that the present embodiment will be described assuming that a single processor realizes the system control function 91, the acquisition function 92, the management function 93, and the output function 94. However, the embodiment is not limited to such a configuration. For example, multiple independent processors may be used in combination to form the control circuitry to have the respective processors execute the control programs, so that the system control function 91, the acquisition function 92, the management function 93, and the output function 94 will be realized. Note also that it is assumed, for descriptive purposes, that the control circuitry 9 has such discrete functions, and the functions of the control circuitry 9 are not limited by the explanation herein. For example, each function of the control circuitry 9 may be partially or entirely incorporated into the system control function 91, or the system control function 91 may be partially incorporated into the acquisition function 92, the management function 93, and/or the output function 94. Also, the acquisition function 92 and/or the output function 94 may be partially or entirely incorporated into the management function 93. The management function 93 may be partially or entirely incorporated into the acquisition function 92 and/or the output function 94.

The system control function 91 is a function to take total control over the components of the automatic analyzer 1 according to input information input via the input interface 5. For example, the control circuitry 9 controls each component so that measurement with a sample, calibration measurement with a standard sample, controlled measurement with a standard sample, etc. will be performed. Here, calibration measurement refers to a measurement operation for preparing a fresh calibration curve. Controlled measurement refers to a measurement operation required for managing the accuracy of prepared calibration curves or a currently set calibration curve. More specifically, for these measurement operations, the control circuitry 9 controls the drive mechanism 4 and also the analysis mechanism 2 for operational actions such as the rotation of a reaction disk 205, the pivoting and dispensing action of a sample dispensing probe 216, and the rotation and discharging action of one or more reagent racks, as will be described. The control circuitry 9 also controls the analysis circuitry 3 to perform analysis corresponding to the test items. The control circuitry 9 may be provided with a storage area for storing at least a portion of the data stored in the memory 8. The system control function 91 is one example of a controller. The measurement for preparing a calibration curve may be called “calibration measurement”. The measurement for accuracy management may be called “fresh controlled measurement”.

The acquisition function 92 is a function to acquire standard sample information corresponding to a given standard sample via a reader furnished at the analysis mechanism 2. The acquisition function 92 may acquire standard sample information including at least one of item information, identification information for the identification as a calibrator or an accuracy management sample, and/or concentration information, from the standard sample container containing the standard sample. For example, the acquisition function 92 may acquire the standard sample information at at least one of the timing where a user instruction is accepted and/or the timing where the preparation for standard sample measurement is started. However, the acquisition timing is not limited to this, and the acquisition function 92 may additionally or instead acquire the standard sample information at, for example, at least one of the timing where the automatic analyzer 1 is activated, the timing during a startup process, and/or the timing during a shutdown process. Also for example, the acquisition function 92 may acquire standard sample information including item information, identification information for the identification as a calibrator or an accuracy management sample, and concentration information, by accepting an input of such standard sample information given according to a user operation. The reader and the acquisition function 92 constitute one example of a first acquirer. The input interface 5 and the acquisition function 92 constitute one example of a second acquirer.

The management function 93 is a function to manage the condition of a standard sample contained in a standard sample container. The management function 93 may update the condition information on the condition of a standard sample upon acquisition of the corresponding standard sample information. Note that the condition information may include information on at least one of the expiration timing of a standard sample and/or the remaining amount of the standard sample. For example, the management function 93 may update information indicative of the date and time of acquisition of a standard sample as the information on the expiration timing of the standard sample. Also for example, the management function 93 may update information indicative of the number of uses of a standard sample as the information on the remaining amount of the standard sample. Preferably, the information indicative of the number of uses is updated after standard sample measurement, but this is not a limitation. Information on the expiration timing, information indicative of the number of uses, etc. may be included in the acquisition-subject standard sample information or may be input as the condition information according to a user operation.

The management function 93 may also determine whether or not a standard sample is unusable based on the condition information. For example, the management function 93 may determine, based on the condition information, whether or not a standard sample is either in an expired state or in a state of showing a sign of expiration. Also for example, the management function 93 may determine, based on the condition information, whether or not a standard sample is either in an insufficient remaining amount state or in a state of showing a sign of an insufficient remaining amount. The management function 93 is one example of an updater, each determiner, and a changer.

The output function 94 is a function to output various datasets, etc., including results of processing by the system control function 91, the acquisition function 92, and the management function 93, via the output interface 6. For example, the output function 94 may output, based on the result of determination by the management function 93, information on an expired state of a standard sample or an expiration-sign-showing state of the standard sample. Also for example, the output function 94 may output, based on the result of determination by the management function 93, information on an insufficient remaining amount state of a standard sample or an insufficient-remaining-amount-sign-showing state of the standard sample. The output function 94 may also output the condition information together with a measurement result. Note that the output by the output function 94 is assumed to be in the form of printing, storing into a memory or the like, transmitting to a host personal computer (PC) or the like using online communications, and so on, but no limitation is intended. The output function 94 may output standard sample information and condition information at the time of outputting a result of measurement with a standard sample or a subject sample. The output function 94 is one example of each outputter.

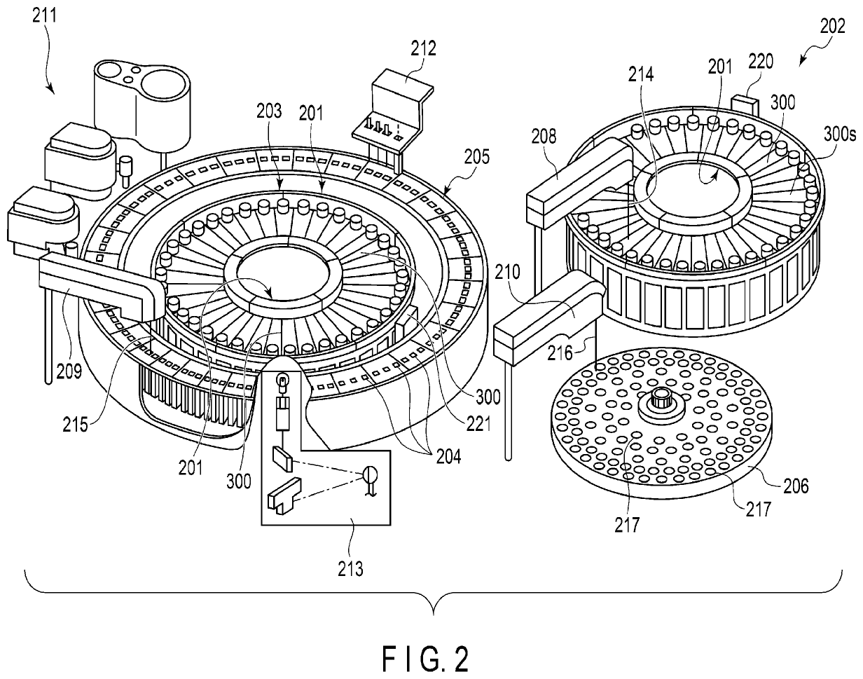

FIG. 2 is a schematic diagram showing an exemplary design of the analysis mechanism 2 shown in FIG. 1. This analysis mechanism 2 includes: reagent containers 300 each containing a reagent such as a first reagent which selectively reacts with a subject sample for a given item or with a calibrator for the item, or a second reagent which is used with the first reagent in pairs; one or more standard sample containers 300s each airtightly containing a standard sample; reagent racks 201 each holding the reagent containers 300 and/or one or more standard sample containers 300s; a first reagent depository 202 enclosing and refrigerating one or more of the reagent racks 201 that hold the reagent containers 300 each containing the first reagent and one or more standard sample containers 300s; a second reagent depository 203 enclosing and refrigerating one or more of the reagent racks 201 that hold the reagent containers 300 each containing the second reagent; a reaction disk 205 with multiple circumferentially arranged reaction containers 204; and a disk sampler 206 set with subject sample containers 217 containing respective subject samples or calibrators. Note that one or more standard sample containers 300s may be kept in either the first reagent depository 202 or the second reagent depository 203, or may be held in both of these depositories. By way of example, the description will assume that one or more standard sample containers 300s are kept only in the first reagent depository 202. The first reagent depository 202 is one example of a reagent depository.

The first reagent depository 202, the second reagent depository 203, and the disk sampler 206 are each independently rotated while the reaction disk 205 is rotated to stop at a given position under the control of the control circuitry 9 at, for example, every one cycle.

The analysis mechanism 2 also includes a first reagent dispensing probe 214 and a second reagent dispensing probe 215 for aspirating respective first and second reagents from the reagent containers 300 located at respective first and second reagent aspirating positions on the first and second reagent depositories 202 and 203, and for dispensing the respective first and second reagents into the reaction containers 204 stopped at respective first and second reagent dispensing positions, at every one cycle, for example. The analysis mechanism 2 further includes a sample dispensing probe 216 for aspirating a subject sample or a calibrator from the subject sample container 217 located at the position on the disk sampler 206 under the control of the control circuitry 9, and for dispensing the subject sample or the calibrator into the reaction container 204 stopped at a subject sample dispensing position, at every one cycle, for example.

Also, the analysis mechanism 2 includes a first reagent dispensing arm 208, a second reagent dispensing arm 209, and a dispensing arm 210 adapted to hold the respective first reagent dispensing probe 214, second reagent dispensing probe 215, and sample dispensing probe 216 in such a manner that these probes can pivot and vertically ascend and descend.

Moreover, the analysis mechanism 2 includes: a stirring unit 211 for stirring a mixture liquid in the reaction container 204 stopped at a stirring position at, for example, every one cycle; a photometry unit 213 for measuring this mixture liquid in the reaction container 204 from a photometry position at, for example, every one cycle; and a washing unit 212 for suctioning the measurement-completed mixture liquid from the reaction container 204 stopped at a washing and drying position and also for washing and drying the inside of this reaction container 204 at, for example, every one cycle. Examples of the mixture liquid that can be suitably handled here include (i) a mixture liquid containing the subject sample and the first reagent, (ii) a mixture liquid containing the calibrator and the first reagent, (iii) a mixture liquid containing the subject sample, the first reagent, and the second reagent, (iv) a mixture liquid containing the calibrator, the first reagent, and the second reagent, and so on.

The photometry unit 213 is disposed near the outer circumference of the reaction disk 205. The photometry unit 213 optically measures given components in the mixture liquid of the sample and the reagent discharged and present in the reaction container 204. The photometry unit 213 includes a light source and a photodetector. Under the control of the control circuitry 9, the photometry unit 213 emits light from the light source. The emitted light enters the reaction container 204 through a first sidewall and exits the reaction container 204 through a second sidewall opposite the first sidewall. The photometry unit 213 detects the light coming out of the reaction container 204 using the photodetector.

More specifically, the photodetector in one example detects light that has passed through the mixture liquid of a standard sample and a reagent in the reaction container 204, and generates standard data represented as an absorbency level, etc., based on the intensity of the detected light. In one example, the photodetector also detects light that has passed through the mixture liquid of a subject sample and a reagent in the reaction container 204, and generates subject data represented as an absorbency level, etc., based on the intensity of the detected light. The photometry unit 213 outputs the generated standard data and subject data to the analysis circuitry 3.

The washing unit 212 is disposed near the outer circumference of the reaction disk 205. The washing unit 212 washes the inside of the reaction containers 204 for which the measurement of the mixture liquid by the photometry unit 213 has been finished. The washing unit 212 includes a washing liquid supply pump (not illustrated in the figures) for supplying a washing liquid to wash the reaction containers 204. The washing unit 212 also includes a washing nozzle for discharging the washing liquid supplied from the washing liquid supply pump into the reaction container 204 and for suctioning each of the mixture liquid and the washing liquid remaining in the reaction container 204.

The analysis mechanism 2 further includes a first reader 220 for reading standard sample information indicated by the standard sample container 300s kept in the first reagent depository 202. In one example, the first reader 220 is provided outside the first reagent depository 202. The first reader 220 optically reads an optical mark on an information label affixed to the back face of each standard sample container 300s, and for this purpose, the first reagent depository 202 has one or more windows in the side portion of its housing. Each window is, for example, formed in a rectangular slit shape extending from the upper end to the lower end of the side portion of the housing of the first reagent depository 202. The first reader 220 emits a bright line from its light emitter (not illustrated in the figures) so that the bright line travels through the window and hits the information label. The information label diffusely reflects the light, which then travels through the window and enters the light receiver (not illustrated in the figures) of the first reader 220. The analysis mechanism 2 likewise includes a second reader 221 for reading standard sample information indicated by the standard sample container 300s kept in the second reagent depository 203. The second reader 221 and the second reagent depository 203 have similar configurations to the first reader 220 and the first reagent depository 202, respectively.

In controlling each component in order to perform various measurement operations as discussed above, the control circuitry 9 controls corresponding mechanisms, etc., for the rotation of each of the first reagent depository 202, the second reagent depository 203, and the disk sampler 206, the rotation of the reaction disk 205, the rotation and vertical movement of each of the dispensing arm 210, the first reagent dispensing arm 208, the second reagent dispensing arm 209, and the stirring unit 211, and the vertical movement of the washing unit 212.

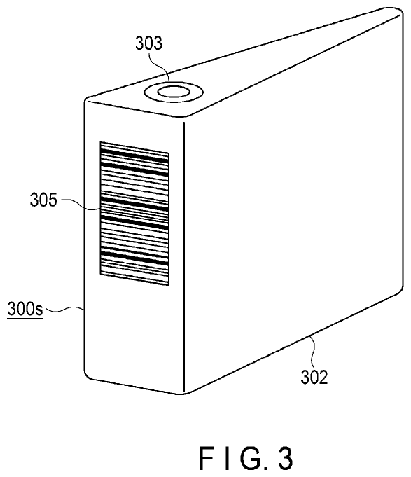

Next, an example of the standard sample container 300s for use with the automatic analyzer configured as above, as well as an example of the peripheral structure of the standard sample container 300s, will be described with reference to FIGS. 3 to 5. FIG. 3 is a schematic diagram showing one example of an appearance of each standard sample container 300s. Note, however, that the standard sample container 300s is not limited to the design or structure shown in FIGS. 3 to 5. The standard sample container 300s is one example of a standard sample container.

The standard sample container 300s includes, as shown in FIGS. 3 to 5, a soft container 301, a casing 302, a probe connector 303, a take-out part 304, and an information label 305. As shown in FIG. 3, the casing 302 of the standard sample container 300s has a shape of, for example, a quadratic prism with trapezoidal bottom and top faces. The top face of the casing 302 has the take-out part 304 for enabling aspirating operations. The information label 305 is affixed to the back face of the casing 302, among the side faces of the casing 302. The back face refers to, in a state where the standard sample container 300s is annularly arranged in the first reagent depository 202 with other containers, a portion facing circumferentially outside.

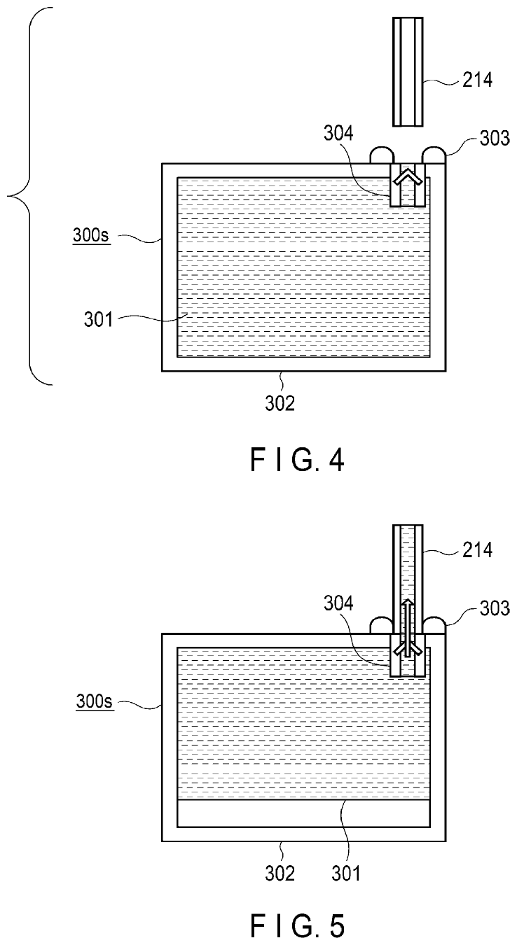

The soft container 301 is a flexible container in which a standard sample for use by the automatic analyzer 1 for the preparation of a calibration curve or the management of accuracy is contained as shown in FIGS. 4 and 5. The soft container 301 is adapted to maintain the standard sample in an airtight manner. The standard sample here is a liquid which contains a measurement target substance at a given concentration. More specifically, and for example, the standard sample is a solution in which a component to be analyzed for a test item is contained at a known concentration. The soft container 301 is formed of a material softer or more flexible than the casing, and such a material may be, for example, a resin film. Examples of the material of the soft container 301 include a polymer material selected from the group consisting of polyethylene, polytetrafluoroethylene, polypropylene, polyurethane, polyvinylidene chloride, polyvinyl chloride, polyacetal, polystyrene, polyacrylonitrile, and polybutylene. The soft container 301 is constituted by a film (a resin film) of the selected polymer material or materials. Use of this soft container 301 enables the standard sample container 300s to prevent the standard sample from being exposed to air. The soft container 301 is enclosed within the casing 302 in such a manner that it is attached to the casing 302 via the probe connector 303 and the take-out part 304 while being penetrated by the take-out part 304.

Also, the soft container 301 is formed with one or more creases. As the standard sample is aspirated through the take-out part 304 by the first reagent dispensing probe 214, the amount of the standard sample in the soft container 301 decreases. At the same time, the soft container 301 with one or more creases shrinks. The soft container 301 can accordingly suppress the foam generation from the standard sample during its movement, such as during the transportation of the standard sample container 300s or during the rotation of the rotary table after the transportation. To be more specific, since the standard sample is sealed in the soft container 301 formed of a soft material, e.g., a resin film, the standard sample foams very little due to ruffles in its surface. For the sake of convenience, the description will simply state that the standard sample is contained in the standard sample container 300s.

The casing 302 encloses the soft container 301 in a non-airtight state. In one example, the casing 302 has an opening (not illustrated in the figures) to the outside air, which creates the non-airtight state of the casing 302. The casing 302 secures the probe connector 303 and the take-out part 304. The casing 302 is formed of, for example, a metal material or a polymer material.

The probe connector 303 is secured to a portion of the casing 302 and serves as a component to detachably connect the first reagent dispensing probe 214 to the take-out part 304.

The take-out part 304 is secured to another portion of the casing 302 and serves as a component to enable the first reagent dispensing probe 214 to aspirate the standard sample contained in the soft container 301. The take-out part 304 may include a valve for blocking a back-flow from the outside toward the inside of the soft container 301. The first reagent dispensing probe 214 is one example of a dispensing probe.

The information label 305 includes an optical mark which is, for example, printed and indicative of given standard sample information. Examples of the optical mark which may be employed here include a two-dimensional code such as a barcode or a QR code (registered trademark). The information label 305 may be replaced with a radio frequency identifier (RFID) which can transmit the standard sample information. In such cases, the RFID may be arranged at, for example, the top face of the casing 302. The RFID may also be called a wireless tag.

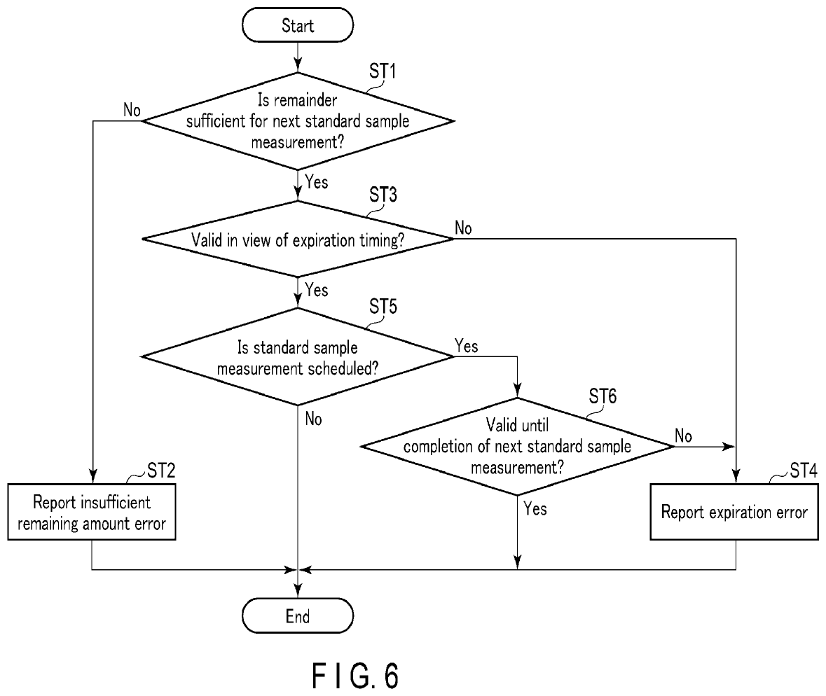

Next, exemplary operations of the automatic analyzer 1 configured as above will be described with reference to the flowchart in FIG. 6. It will be assumed that the exemplary operations handle one standard sample container 300s for checking the condition of the standard sample in advance of standard sample measurement. The control circuitry 9, for example, reads one or more control programs stored in the memory 8 at the activation of the automatic analyzer 1 to perform the system control function 91. Also, the control circuitry 9 performs the acquisition function 92, the management function 93, and the output function 94 upon receipt of a user instruction or at the beginning of the preparation for the measurement.

Note that, in describing probe operations, etc. below, explanatory statements referring to drive actions by the drive mechanism 4 for each component (such as “with the assistance of the drive mechanism 4” or “driven by the drive mechanism 4”) will be omitted. Also, unless otherwise stated, the description will assume that the control circuitry 9 controls each component for each operation. The subsequent flowcharts and their associated description will be given in the same manner.

First, in the state where an unopened standard sample container 300s is placed in the first reagent depository 202 of the automatic analyzer 1, the control circuitry 9 acquires standard sample information from the standard sample container 300s through the first reader 220. The control circuitry 9 stores the acquired standard sample information, as well as condition information on the condition of the standard sample corresponding to this standard sample information, in the memory 8. The condition information here includes, for example, the date and time of placement of the standard sample container 300s and the available number of uses. At the time of opening the standard sample container 300s, the condition information is updated by additionally reflecting the date and time of opening of the standard sample container 300s and the remaining number of uses. This enables the processing in step ST1 and the subsequent steps as will be discussed.

### (Step ST1)

For example, upon acquiring the standard sample information from the standard sample container 300s through the first reader 220 at the beginning of the preparation for standard sample measurement, the control circuitry 9 updates the condition information to additionally reflect the date and time of acquisition of the standard sample information and stores the updated condition information. The control circuitry 9 also determines whether or not the standard sample is in an insufficient remaining amount state based on the condition information. For example, the control circuitry 9 determines whether or not an amount for the next standard sample measurement remains. More specifically, the control circuitry 9 here determines whether or not the latest number of uses (as a remainder) in the condition information is equal to or greater than the number of uses (a threshold value) for the next standard sample measurement. If it is determined in step ST1 that the remaining amount is insufficient, the processing transitions to step ST2. If it is determined that the remaining amount is sufficient, the processing transitions to step ST3.

### (Step ST2)

The control circuitry 9, upon determining that the remaining amount is insufficient (ST1: No), causes the output interface 6 to output information about the insufficient remaining amount state of the standard sample based on the determination result. The control circuitry 9 in this manner reports an error attributed to the insufficient standard sample amount to the user so that the user is prompted for replacement. The control circuitry 9 then terminates the processing. Thereafter, for example, upon placement of another standard sample container 300s in the automatic analyzer 1 afresh, the corresponding standard sample information and condition information will be stored in the memory 8 and then the processing in step ST1 and the subsequent steps will be performed in a similar manner as discussed above.

### (Step ST3)

The control circuitry 9, upon determining that the remaining amount is sufficient (ST1: Yes), updates and stores the condition information in such a manner as to subtract the number of uses for the next standard sample measurement from the latest available number of uses included in the condition information and to associate the number of uses after the subtraction with the latest acquisition date and time.

The control circuitry 9 then determines whether or not the standard sample is valid in view of its expiration timing based on the condition information. For example, the control circuitry 9 compares the date and time of opening included in the condition information with the current date and time to determine whether or not the standard sample is expired. If invalidity in view of the expiration timing is determined in step ST3, the processing transitions to step ST4. If validity in view of the expiration timing is determined, the processing transitions to step ST5.

### (Step ST4)

The control circuitry 9, upon determining the invalidity of the standard sample in view of the expiration timing (ST3: No), causes the output interface 6 to output information about the expired state of the standard sample based on the determination result. The control circuitry 9 in this manner reports an error attributed to the expiration of the standard sample to the user so that the user is prompted for replacement. The control circuitry 9 then terminates the processing. Thereafter, as discussed above, upon placement of another standard sample container 300s in the automatic analyzer 1 afresh, the corresponding standard sample information and condition information will be stored in the memory 8 and then the processing in step ST1 and the subsequent steps will be performed in a similar manner.

### (Step ST5)

The control circuitry 9, upon determining the validity of the standard sample in view of the expiration timing (ST3: Yes), determines whether or not a reservation for the next standard sample measurement has been made. If it is determined in step ST5 that the reservation has not been made, the processing is terminated, and if it is determined that the reservation has been made, the processing transitions to step ST6.

### (Step ST6)

After step ST5, the control circuitry 9 determines whether or not the standard sample will be valid until the completion of the next standard sample measurement in view of the expiration timing. If invalidity in view of the expiration timing is determined in step ST6, the processing transitions to step ST4 where an error attributed to the expiration is reported. If the validity until the completion of the next measurement is determined, the processing is terminated.

After step ST6, the automatic analyzer 1 performs the standard sample measurement and outputs the measurement result together with the condition information from the output interface 6. The automatic analyzer 1 here may also output the standard sample information.

According to the first embodiment as described above, the control circuitry 9 of the automatic analyzer 1 acquires standard sample information including at least one of item information, identification information for the identification as a calibrator or an accuracy management sample, and/or concentration information, from the standard sample container containing a standard sample. Upon acquisition of the standard sample information, the control circuitry 9 updates condition information on the condition of the standard sample. Therefore, the use of the standard sample in an inadequate condition can be prevented based on the condition information on the condition of the standard sample.

Also according to the first embodiment, the control circuitry 9 may acquire the standard sample information at at least one of the timing where a user instruction is accepted and/or the timing where the preparation for standard sample measurement is started. With this configuration, it is possible to acquire the standard sample information and update the condition information at the timing where the degree of necessity of checking the standard sample condition is high.

Also according to the first embodiment, the control circuitry 9 may acquire the standard sample information including item information, identification information for the identification as a calibrator or an accuracy management sample, and concentration information, by accepting an input of such standard sample information given according to a user operation. Here, the control circuitry 9, upon acquisition of the standard sample information, may update the condition information on the condition of the standard sample. With this configuration, also in the instances where the standard sample information is input through a user operation, the use of the standard sample in an inadequate condition can be prevented based on the condition information on the condition of the standard sample.

Also according to the first embodiment, the condition information may include information on at least one of the expiration timing of a standard sample and/or the remaining amount of the standard sample. With this configuration, the use of the standard sample in an inadequate condition can be prevented based on the information on at least one of the expiration timing of the standard sample and/or the remaining amount of the standard sample. For example, it is possible to prevent a standard sample measurement that would produce an invalid outcome due to the use of an expired standard sample or an insufficient amount of the standard sample.

Also according to the first embodiment, the control circuitry 9 determines whether or not a standard sample is in an expired state based on the condition information. The control circuitry 9 provides an output of information about the expired state based on the determination result. Therefore, use of the standard sample in the expired state can be avoided.

Also according to the first embodiment, the control circuitry 9 determines whether or not a standard sample is in an insufficient remaining amount state based on the condition information. The control circuitry 9 provides an output of information about the insufficient remaining amount state based on the determination result. Therefore, use of the standard sample in the insufficient remaining amount state can be avoided.

Also according to the first embodiment, the control circuitry 9 stores the condition information set or sets for a predetermined placement quantity and/or a predetermined period in the memory 8. This enables condition management of standard samples to an appropriate extent according to the predetermined placement quantity and/or the predetermined period.

Also according to the first embodiment, the control circuitry 9 outputs the condition information together with a measurement result. This enables a comparative analysis using the measurement result and the condition of the standard sample, and accordingly allows for easy checking of the condition information on a standard sample that has been used in, for example, the preparation of a calibration curve, the management of accuracy, etc. Moreover, if, for example, a question arises in the measurement result, a burden of investigating the cause can be mitigated.

### (Modifications)

The first embodiment has assumed a configuration of determining whether or not a standard sample is in an expired state, but this is not a limitation. For example, the control circuitry 9 may determine whether or not a standard sample is in a state of showing a sign of expiration, based on the condition information. Criteria for determining such a sign-showing state may be a relaxed version of the criteria for determining the expired state. The control circuitry 9 may also provide an output of information about the expiration-sign-showing state based on the determination result. According to this modification, use of the standard sample in the state of showing a sign of expiration can also be avoided.

The first embodiment has assumed that the condition information includes information on an expiration timing, while the standard sample information does not. However, this is not a limitation, and the standard sample information may include information on an expiration timing. In this case, the control circuitry 9 compares the expiration timing included in the standard sample information with the current date and time so that it can determine whether or not the standard sample is either in the expired state or in the state of showing a sign of expiration. Such a modification can also provide the same effects and advantages as described for the first embodiment.

Also, the first embodiment has assumed a configuration of determining whether or not a standard sample is in an insufficient remaining amount state, but this is not a limitation. For example, the control circuitry 9 may determine whether or not a standard sample is in a state of showing a sign of an insufficient remaining amount, based on the condition information. Criteria for determining such a sign-showing state may be a relaxed version of the criteria for determining the insufficient remaining amount state. The control circuitry 9 may also provide an output of information about the insufficient-remaining-amount-sign-showing state based on the determination result. According to this modification, use of the standard sample in the state of showing a sign of an insufficient remaining amount can also be avoided.

The first embodiment has assumed that the standard sample information does not include information on the remaining (available) number of uses. However, this is not a limitation, and the standard sample information may include the information on the remaining number of uses. In this case, the control circuitry 9 compares the remaining number of uses included in the standard sample information with the number of uses in the condition information (i.e., the number of times the standard sample has been used) so that it can determine whether or not the standard sample is either in the insufficient remaining amount state or in the state of showing a sign of an insufficient remaining amount. Such a modification can also provide the same effects and advantages as described for the first embodiment.

The first embodiment has assumed an instance where the standard sample container 300s is kept in the first reagent depository 202, but this is not a limitation. For example, the standard sample container 300s may be kept in the second reagent depository 203 or in a standard sample depository (not illustrated in the figures). Such a modification can also provide the same effects and advantages as described for the first embodiment.

The first embodiment has assumed a configuration of optically reading standard sample information from the information label 305 on a standard sample container 300s, but this is not a limitation. For example, an RFID may be provided to the standard sample container 300s and the standard sample information may be wirelessly read from the RFID. Such a modification can also provide the same effects and advantages as described for the first embodiment. Further, in this case, the RFID is not limited to a read-only type, but it is also possible to employ a readable/writable RFID. For example, the standard sample information may be wirelessly read from such an RFID provided to the standard sample container 300s, and the condition information may be wirelessly written in the RFID. In this case, the RFID of the standard sample container 300s retains both the standard sample information and the condition information, and therefore, even if a failure occurs in the automatic analyzer 1, the standard sample measurement can be continued by transferring the standard sample container 300s to another automatic analyzer.

The modifications of the first embodiment have been described. These modifications are likewise applicable to each embodiment, etc., disclosed below.

### Second Embodiment

In contrast to the exemplary operations according to the first embodiment, in which placement of one standard sample container 300s has been assumed, the second embodiment assumes placement of multiple standard sample containers 300s. That is, the second embodiment enables, in an event where a standard sample in an inadequate condition in view of the expiration timing or the remaining mount is involved, a changeover (switchover) to another standard sample.

Accordingly, the control circuitry 9 has a function of determining whether or not a standard sample for use in measurement is unusable based on the condition information, and if the standard sample is determined to be unusable, changing the standard sample to a standard sample that is of the equivalent type to the unusable standard sample. Here, the unusable standard sample is, for example, a standard sample in an inadequate condition in view of the expiration timing or the remaining amount. Standard sample information corresponding to the equivalent-type standard sample may include, for example, the same item information and identification information as those included in the standard sample information corresponding to the unusable standard sample, and it may further include the same concentration information. The item information being the same means, for example, that measurement items such as total protein or total serum protein (TP), albumin (ALB), aspartate aminotransferase (AST), alanine aminotransferase (ALT), and high-density lipoprotein (HDL) are the same. The identification information being the same means that the identification as to whether the standard sample is a calibrator or an accuracy management sample, i.e., a sample type that complies with a measurement mode, is the same. The measurement mode here is, for example, a calibration measurement or an accuracy management measurement (controlled measurement). In other words, the equivalent-type standard sample is a standard sample that is intended for the same measurement item as that of the unusable standard sample and is also of the same measurement-mode-complying sample type as that of the unusable standard sample. The equivalent-type standard sample may also be a standard sample that further has the same concentration. In this relation, there are occasions where standard samples under different lot numbers have different concentration values, and as such, the equivalent-type standard sample here is not required to have the same concentration. Note that, in the case where the equivalent-type standard sample could be a standard sample under a different lot number, the concentration information associated with the lot number may be included in the standard sample information so that the concentration information on the standard sample for use in measurement can be automatically updated.

In an example, if an unusable standard sample is an accuracy management sample, and if there is no equivalent-type standard sample but there is a calibrator having the same item information as that of the unusable standard sample, the control circuitry 9 may change the standard sample for use in measurement to this calibrator. Then, if, by comparison, a difference between the result of the measurement and the result of the previous calibration measurement both using this changeover-target calibrator falls outside a predetermined range, the control circuitry 9 may give an output indicating an error. This error corresponds to a reagent condition being invalid. The control circuitry 9 is one example of a third determiner, a changer, and a third outputter.

The remaining aspects are the same as the first embodiment.

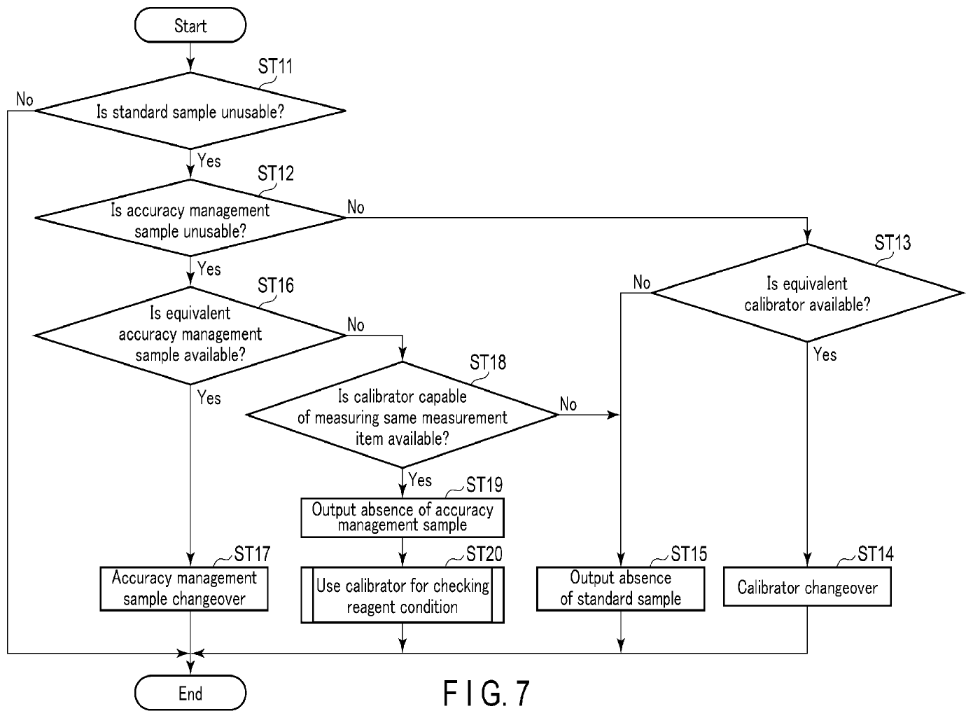

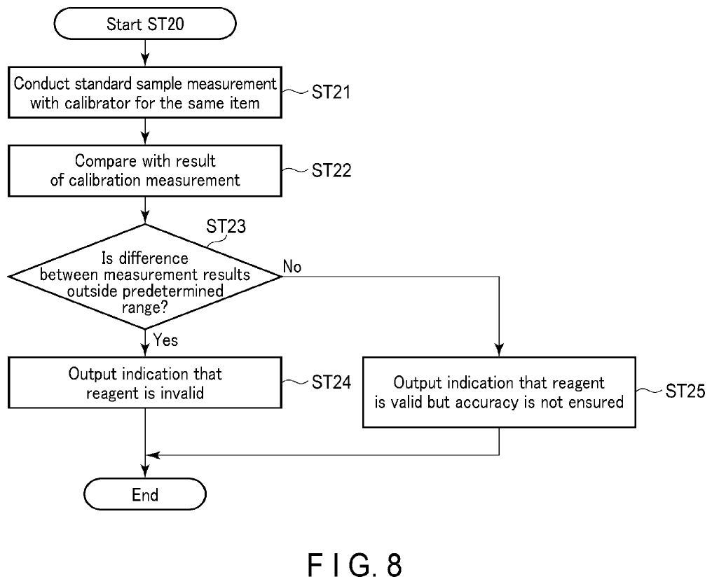

Next, exemplary operations of the automatic analyzer 1 configured as above will be described with reference to the flowcharts in FIGS. 7 and 8. It will be assumed that the exemplary operations handle multiple standard sample containers 300s for checking the conditions of the standard samples in advance of standard sample measurement.

An outline of the operations will be described first. As shown in FIG. 7, in the case where a standard sample is unusable, determination as to whether this unusable standard sample is an accuracy management sample or a calibrator is made (ST11 to ST12).

If it is determined that the unusable standard sample is a calibrator, and if there is an equivalent-type calibrator in place, a calibrator changeover is conducted. On the other hand, if there is no equivalent-type calibrator, an indication of the non-existence of a standard sample is output (ST13 to ST15).

If it is determined that the unusable standard sample is an accuracy management sample, and if there is an equivalent-type accuracy management sample in place, an accuracy management sample changeover is conducted. On the other hand, if there is no equivalent-type accuracy management sample, determination as to whether or not there is a calibrator intended for the same item is made (ST16 to ST18). If there is no calibrator intended for the same item, an indication of the non-existence of a standard sample is output. If such a calibrator is in place, an indication of the non-existence of an accuracy management sample is output and this same-item-intended calibrator is used for checking a reagent condition (ST19 to ST20).

For checking the reagent condition, the result of the standard sample measurement using the same-item-intended calibrator is compared with the result of the calibration measurement using this calibrator, and the difference between these results is referred to for determining whether or not the reagent is in a valid state (ST21 to ST25).

The outline of the exemplary operations has been given. The exemplary operations will be explained in more detail, with reference to the flowcharts in FIGS. 7 and 8.

### (Step ST11)

The control circuitry 9 determines whether or not a standard sample is unusable based on the condition information. If the standard sample is determined to be unusable, the control circuitry 9 transitions to step ST12. If not (if the standard sample is usable), the control circuitry 9 terminates the processing. After the termination of processing, measurement with this usable standard sample is conducted.

### (Step ST12)

The control circuitry 9 determines whether or not an accuracy management sample is unusable. More specifically, the control circuitry 9 determines whether or not the unusable standard sample is an accuracy management sample based on the standard sample information. Upon determining “No”, the control circuitry 9 transitions to step ST13. If the unusable standard sample is determined to be an accuracy management sample, the control circuitry 9 transitions to step ST16.

### (Step ST13)

The control circuitry 9 determines whether or not a calibrator that is of the equivalent type to the unusable standard sample (calibrator) is in place, based on the standard sample information sets stored in the memory 8. The equivalent-type calibrator here refers to a standard sample that is intended for the same measurement item as that of the unusable standard sample (calibrator) and is also associated with identification information indicating a calibrator. The level information on the unusable calibrator, if any, may be overwritten by the concentration information obtained from the standard sample information on the calibrator that is in place. If it is determined in step ST13 that an equivalent-type calibrator is in place, the processing transitions to step ST14, and if not, the processing transitions to step ST15.

### (Step ST14)

The control circuitry 9 conducts a calibrator changeover (switchover) of replacing the unusable standard sample (original) with the equivalent-type calibrator (substitute). The control circuitry 9 also reports this to the user by causing the output interface 6 to output the information about the original standard sample and the substitute standard sample. The report to the user may take a message form, or any other desired form such as a form of indicating the original and substitute standard samples on a screen for standard samples. Upon completing step ST14, the processing is terminated. After the termination of processing, measurement with this substitute calibrator is conducted.

### (Step ST15)

The control circuitry 9 causes the output interface 6 to output an indication that the standard sample is unusable and that there is no backup standard sample in place. The control circuitry 9 in this manner reports the absence of a standard sample for use in measurement to the user so that the user is prompted for replacement. Upon completing step ST15, the processing is terminated. After the termination of processing, one or more standard sample containers 300s are newly placed in the automatic analyzer 1.

### (Step ST16)

The control circuitry 9 determines whether or not an accuracy management sample that is of the equivalent type to the unusable standard sample (accuracy management sample) is in place, based on the standard sample information sets stored in the memory 8. The equivalent-type accuracy management sample here refers to a standard sample that is intended for the same measurement item as that of the unusable standard sample (accuracy management sample), is associated with identification information indicating an accuracy management sample, and also has the same concentration as that of the unusable standard sample. If it is determined in step ST16 that an equivalent-type accuracy management sample is in place, the processing transitions to step ST17, and if not, the processing transitions to step ST18.

### (Step ST17)

The control circuitry 9 conducts an accuracy management sample changeover (switchover) of replacing the unusable standard sample (original) with the equivalent-type accuracy management sample (substitute). The control circuitry 9 also reports this to the user by causing the output interface 6 to output the information about the original standard sample and the substitute standard sample. As discussed above, the report to the user may take any other desired form. Upon completing step ST17, the processing is terminated. After the termination of processing, measurement with this substitute accuracy management sample is conducted.

### (Step ST18)

The control circuitry 9 determines whether or not a calibrator that is capable of measuring the same item as that of the unusable standard sample (accuracy management sample) is in place, based on the standard sample information sets stored in the memory 8. The calibrator that is capable of measuring the same item refers to a standard sample that is intended for the same measurement item as that of the unusable standard sample (accuracy management sample), is associated with identification information indicating a calibrator, and also has the same concentration as that of the unusable standard sample. If it is determined in step ST18 that a calibrator that is capable of measuring the same item is in place, the processing transitions to step ST19, and if not, the processing transitions to step ST15.

### (Step ST19)

The control circuitry 9 causes the output interface 6 to output an indication that the standard sample (accuracy management sample) is unusable, that there is no backup standard sample (accuracy management sample) in place, and that a calibrator capable of measuring the same item is in place. The control circuitry 9 in this manner reports the absence of an accuracy management sample for use in measurement to the user. Upon completing step ST19, the processing transitions to step ST20.

### (Step ST20)

The control circuitry 9 uses the calibrator capable of measuring the same item, for the purpose of checking a reagent condition. This step ST20 is constituted by steps ST21 to ST25, which proceed as follows.

### (Step ST21)

Using the calibrator capable of measuring the same item, the control circuitry 9 conducts standard sample measurement to obtain the measurement result.

### (Step ST22)

The control circuitry 9 compares the measurement result obtained in step ST21 with the result of calibration measurement that has been performed with this calibrator.

### (Step ST23)

The control circuitry 9, referring to the result of this comparison in step TS22, determines whether or not the difference between the measurement results falls outside a predetermined range. If it is determined that the difference falls outside the predetermined range, the control circuitry 9 transitions to step ST24, and if not, the control circuitry 9 transitions to step ST25.

### (Step ST24)

If the difference between the measurement results is outside the predetermined range, the control circuitry 9 causes the output interface 6 to output an indication that the reagent is not in a valid state. The control circuitry 9 in this manner reports the invalid reagent state to the user, and then terminates the processing.

### (Step ST25)

If the difference between the measurement results falls within the predetermined range, the control circuitry 9 causes the output interface 6 to output an indication that the reagent is in a valid state but the accuracy is not managed. This output indication may use, for example, one or more of a flag, a message, and the maximum measured variation. The maximum measured variation is used because, as one example, if the absorbency level for an item on a linear calibration curve prepared from the use of the same calibrator shows a difference of +1%, the absorbency level obtained from the measurement would also show a difference of approximately +1%, and therefore, an indication of the maximum measured variation of +1 is given to the measurement result. For example, supposing that the measurement result is “100”, the indication may be “100 (Maximum deviation range: +1%)”. As another example, in the case of using curved calibration curves, a variation of +1% in the absorbency level would correspond to a variation of +1% or greater in the measurement result, and accordingly, the indication follows the calibration curves. For example, supposing that the measurement result is “100”, the indication may be “100 (Maximum deviation range: 100 to 105)”. In addition, examples of the curved calibration curves include a 4-parameter logistic curve (Logit-4), a spline curve, and other approximation functions. In any case, the control circuitry 9 gives a report to the user that the reagent is in a valid state but accuracy management has not been done, and then terminates the processing. With this configuration, the automatic analyzer 1 can check the reagent state and continue standard sample measurements even in the event where a valid accuracy management sample is not placed in the automatic analyzer 1.

According to the second embodiment as described above, the control circuitry 9 determines whether or not a standard sample is unusable based on the condition information. Also, the control circuitry 9, if the standard sample is determined to be unusable, changes the standard sample for use in measurement to a standard sample that is of the equivalent type to the unusable standard sample. Therefore, in addition to the effects described for the first embodiment, the second embodiment can also realize the effect that an unusable standard sample can be changed to an equivalent-type standard sample so as to enable the measurement using the standard sample after the changeover.

More specifically, according to the second embodiment, measurement with an invalid standard sample can be prevented from being conducted, and furthermore, a standard sample changeover is performed upon determining the presence of an equivalent-type standard sample in place so that the standard sample measurement can be conducted. This consequently allows for the reduction of labor for placing standard sample containers, preparing measurement orders, and so on. Additionally, if the standard sample in place is a standard sample under a different lot number, the standard sample changeover may be conducted after expiration of the calibration curve. In this case, the concentration information associated with the lot number may be included in the standard sample information so that the concentration information on the standard sample for use in measurement can be automatically updated.

Also according to the second embodiment, standard sample information corresponding to a standard sample that is of the equivalent type to an unusable standard sample may include the same item information, the same identification information, and the same concentration information as those included in the standard sample information corresponding to the unusable standard sample. Thus, the equivalent-type standard sample can be easily located based on the standard sample information.

According to the second embodiment, if an unusable standard sample is an accuracy management sample, and if there is no equivalent-type standard sample but there is a calibrator having the same item information as that of the unusable standard sample, the control circuitry 9 changes the standard sample for use in measurement to the calibrator. Therefore, even in the absence of the equivalent-type accuracy management sample, measurement with a calibrator for the same item is conducted so that the state of alteration of the currently used reagent can be checked. In doing so, the standard sample may be diluted and the standard sample measurement at multiple levels may be conducted.

Also according to the second embodiment, if, by comparison, a difference between the result of the measurement and the result of the previous calibration measurement both using a changeover-target calibrator falls outside a predetermined range, an output indicating an error is given. Thus, if the reagent is in an invalid state, the user can be notified of this and be prompted for replacement.

According to at least one embodiment in the foregoing description, the use of standard samples in an inadequate condition can be prevented.

The terminology “processor” used herein refers to, for example, a central processing unit (CPU) or a graphics processing unit (GPU), or various types of circuitry which may be an application-specific integrated circuit (ASIC), a programmable logic device (such as a simple programmable logic device (SPLD), a complex programmable logic device (CPLD), or a field programmable gate array (FPGA)), and so on. The processor reads a program or programs stored in the memory and executes them to realize corresponding functions. The programs may be incorporated directly in circuits of the processor, instead of being stored in the memory. In this case, the processor reads the programs incorporated in its circuit and executes them to realize the functions. The embodiments herein do not limit each processor to a single circuitry-type processor. Multiple independent circuits may be combined and integrated as one processor to realize the intended functions. Furthermore, multiple components or features as given in FIG. 1 may be integrated as one processor to realize the respective functions.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

What is claimed is:

1. An automatic analyzer configured to dispense a subject sample or a standard sample and a reagent into a reaction container and to subject a mixture liquid in the reaction container to measurement, the automatic analyzer comprising:
control circuitry configured to
acquire, from a standard sample container containing the standard sample, standard sample information comprising at least one of item information, identification information for identification as a calibrator or an accuracy management sample, or concentration information, and
update, upon acquisition of the standard sample information, condition information on a condition of the standard sample.

2. The automatic analyzer according to claim 1, wherein the control circuitry is configured to acquire the standard sample information at at least one of a timing where a user instruction is accepted or a timing where a preparation for measurement with the standard sample is started.

3. The automatic analyzer according to claim 1, wherein the condition information comprises information on at least one of an expiration timing of the standard sample or a remaining amount of the standard sample.

4. The automatic analyzer according to claim 3, wherein the control circuitry is further configured to
determine, based on the condition information, whether or not the standard sample is either in an expired state or in a state of showing a sign of expiration, and
output, based on a result of the determination, information on the expired state or the state of showing a sign of expiration.

5. The automatic analyzer according to claim 3, wherein the control circuitry is further configured to
determine, based on the condition information, whether or not the standard sample is either in an insufficient remaining amount state or in a state of showing a sign of an insufficient remaining amount, and
output, based on a result of the determination, information on the insufficient remaining amount state or the state of showing a sign of an insufficient remaining amount.

6. The automatic analyzer according to claim 3, wherein the control circuitry is further configured to
determine, based on the condition information, whether or not the standard sample is unusable, and
if the standard sample is determined to be unusable, change the standard sample to an equivalent-type standard sample which is equivalent to the standard sample.

7. The automatic analyzer according to claim 6, wherein the standard sample information corresponding to the equivalent-type standard sample comprises item information, identification information, and concentration information equivalent to those included in the standard sample information corresponding to the standard sample determined to be unusable, respectively.

8. The automatic analyzer according to claim 7, wherein the control circuitry is configured so that, if the standard sample determined to be unusable is an accuracy management sample, and if there is no equivalent-type standard sample but a calibrator having same item information as that of the standard sample determined to be unusable, the control circuitry changes the standard sample determined to be unusable to the calibrator.

9. The automatic analyzer according to claim 8, wherein the control circuitry is further configured to
compare a result of measurement performed with the calibrator with a result of previous calibration measurement using the calibrator, and
if a difference between the results falls outside a predetermined range, output an indication of an error.

10. The automatic analyzer according to claim 3, further comprising a memory configured to store one or more sets of the standard sample information and the condition information for a predetermined placement quantity or a predetermined period.

11. The automatic analyzer according to claim 1, wherein the control circuitry is further configured to output the condition information together with a measurement result.

12. An automatic analyzer configured to dispense a subject sample or a standard sample and a reagent into a reaction container and to subject a mixture liquid in the reaction container to measurement, the automatic analyzer comprising:
control circuitry configured to
acquire standard sample information comprising item information, identification information for identification as a calibrator or an accuracy management sample, and concentration information, by accepting an input of the standard sample information given according to a user operation, and
update, upon acquisition of the standard sample information, condition information on a condition of the standard sample.

13. The automatic analyzer according to claim 12, wherein the condition information comprises information on at least one of an expiration timing of the standard sample or a remaining amount of the standard sample.

14. The automatic analyzer according to claim 13, wherein the control circuitry is further configured to
determine, based on the condition information, whether or not the standard sample is either in an expired state or in a state of showing a sign of expiration, and
output, based on a result of the determination, information on the expired state or the state of showing a sign of expiration.

15. The automatic analyzer according to claim 13, wherein the control circuitry is further configured to
determine, based on the condition information, whether or not the standard sample is either in an insufficient remaining amount state or in a state of showing a sign of an insufficient remaining amount, and
output, based on a result of the determination, information on the insufficient remaining amount state or the state of showing a sign of an insufficient remaining amount.

16. The automatic analyzer according to claim 13, wherein the control circuitry is further configured to
determine, based on the condition information, whether or not the standard sample is unusable, and
if the standard sample is determined to be unusable, change the standard sample to an equivalent-type standard sample which is equivalent to the standard sample.

17. The automatic analyzer according to claim 16, wherein the standard sample information corresponding to the equivalent-type standard sample comprises item information, identification information, and concentration information equivalent to those included in the standard sample information corresponding to the standard sample determined to be unusable, respectively.

18. The automatic analyzer according to claim 13, further comprising a memory configured to store one or more sets of the standard sample information and the condition information for a predetermined placement quantity or a predetermined period.

19. The automatic analyzer according to claim 12, wherein the control circuitry is further configured to output the condition information together with a measurement result.

20. An automatic analyzing method for dispensing a subject sample or a standard sample and a reagent into a reaction container and subjecting a mixture liquid in the reaction container to measurement, the automatic analyzing method comprising:
acquiring, from a standard sample container containing the standard sample, standard sample information comprising at least one of item information, identification information for identification as a calibrator or an accuracy management sample, or concentration information; and
updating, upon acquisition of the standard sample information, condition information on a condition of the standard sample.
